(19) United States
(12) Patent Application Publication
(10) Pub. No.: US 2021/0027290 A1
(43) Pub. Date: Jan. 28, 2021

(54) PAYMENT TRANSACTION INITIATION FROM A SENDER TO A RECIPIENT USING RECIPIENT'S BIOMETRIC PARAMETERS AS THE SOLE IDENTIFIER

(71) Applicant: Deepam Tiwan, Austin, TX (US)

(72) Inventor: Deepam Tiwan, Austin, TX (US)

(21) Appl. No.: 16/518,922

(22) Filed: Jul. 22, 2019

(51) Int. Cl. G06Q 20/38; G06Q 20/24; G06K 9/00

(52) U.S. Cl. CPC G06Q 20/3821; G06Q 20/24; G06K 9/00926; G06K 9/00255; G06K 9/00288

(57) ABSTRACT

A software program for initiating a payment transaction from a sender to a recipient and that the recipient lacks a destination account with a financial institution. The sender via the software program installed on a mobile device sends an instruction from a funding source account of the sender. The sender captures a biometric parameter of the recipient via the mobile device as an in-person capture. The mobile device via the software program stores at least a portion of the biometric parameter thereon. The sender sends an instruction via the software program to initiate the payment transaction to transmit funds from the funding source account to the recipient as identified by the biometric parameter. The mobile device transmits via the software program the biometric parameter and the user instruction to a payment server to complete the payment transaction.

### TECHNICAL FIELD

Embodiments discussed herein generally relate to using biometric parameter for authenticating and establishing an account to receive a payment transaction.

### BACKGROUND

The conveniences of cashless payments, whether they card-based or app-based, have brought many lifestyle changes to consumers. Consumers are purchasing more on online stores and merchants and carrying less or no cash when visiting brick-and-mortar stores. In addition, loyalty programs with credit card companies, frequent flier programs, etc., further reduce the incentives for consumers to bring cash with them in person.

Such change of lifestyle create a problem when cash is needed. For example, a consumer may need cash or coins to pay for street parking at a parking meter. Another consumer may need cash or coins to help someone in need, whether the person is a panhandler or a homeless. Yet another consumer may wish to pay a small business that only accepts cash via some other way.

Current solutions involve the consumers trying to locate an ATM nearby. However, sometimes due to the inconvenience of the locations or due to extra fees charged by the consumer's bank institution, the consumer may forgo the intended transactions entirely. In another situation where after obtaining the cash, the consumer may be hesitant to tender the cash. For example, if the consumer wishes to provide financial assistance to the panhandler, the consumer may fear that the panhandler may use the funds for illegal substances or for consumption of alcohol.

Aspects of the invention attempt to create a technical solution to address the deficiencies of the challenges above.

### SUMMARY

Embodiments of the invention create a technical solution to the above challenges by enabling a sender (e.g., a consumer) to perform an in-person capture of a biometric parameter of a recipient (e.g., a panhandler) as a basis for not only to receive funds from the consumer but also to establish an account with a financial institution or other types of institutions where the individual may perform financial transactions based on the biometric parameter.

In one embodiment, aspects of the invention enable the sender to use an app installed on a mobile device to capture a photograph or an image of the recipient. The sender may then use the photograph or the image as an identification or destination to where funds from his or her financial accounts may be directed or transferred. In a further embodiment, the sender may use the app to set a further contingent rule to redirect the funds to another institutions or charity as a donation after the recipient fails to collect the funds. A payment processing network server may receive the instructions, data of the photograph or the image, data of the financial accounts, and the alternative institution or charity's data. The above data is stored for access in response to a request from a participating institution.

In a further embodiment, the recipient may visit the participating institution, which may include a banking institution, a participating kiosk at a convenient store, a supermarket, or the like. The recipient may be requested at the participating institution to obtain the photograph or image (e.g., via a live in-person capture). The participating institution may store the photograph temporarily or may simultaneously forward or transmit the data along with a request to the payment processing network server. The request may ask the payment processing network server to match the captured photograph or image with existing ones in the database. If there is a match, the payment processing network server establishes an account for the recipient so that the account may include the funds from the sender. If there is no match, the payment processing network server may communicate with the participating institution to determine if the recipient wishes to establish an account for future collection of funds.

In yet another embodiment, the payment processing network server may, after receiving the instructions and the relevant data from the sender, perform a preliminary identification or matching of the biometric parameter to determine if a match may be found.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a system diagram for enabling a transaction based on biometric parameters according to one embodiment.

FIG. 2 is a diagram illustrating a data structure in a database maintaining data needed according to one embodiment illustrated in FIG. 1.

FIGS. 3A to 3I are diagrams illustrating a set of GUI for enabling the transaction according to one embodiment.

FIG. 4 is a flowchart illustrating a computerized method according to one embodiment.

FIG. 5 is a diagram illustrating a portable computing device according to one embodiment.

FIG. 6 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure will be thorough and complete, and will fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Aspects of the invention differ technically from prior approach by creating biometric parameters of an individual to be the sole key to fund transfers and before an account associated with the individual has been created. In other words, biometric parameters are no longer just a secondary piece of data or a verification used to verify primary account data. Rather, the biometric parameters are the primary data and that an ad-hoc type of account creation becomes of a secondary consideration. In another embodiment, the biometric parameters both serve as the primary and secondary data for fund creation and transfer verification.

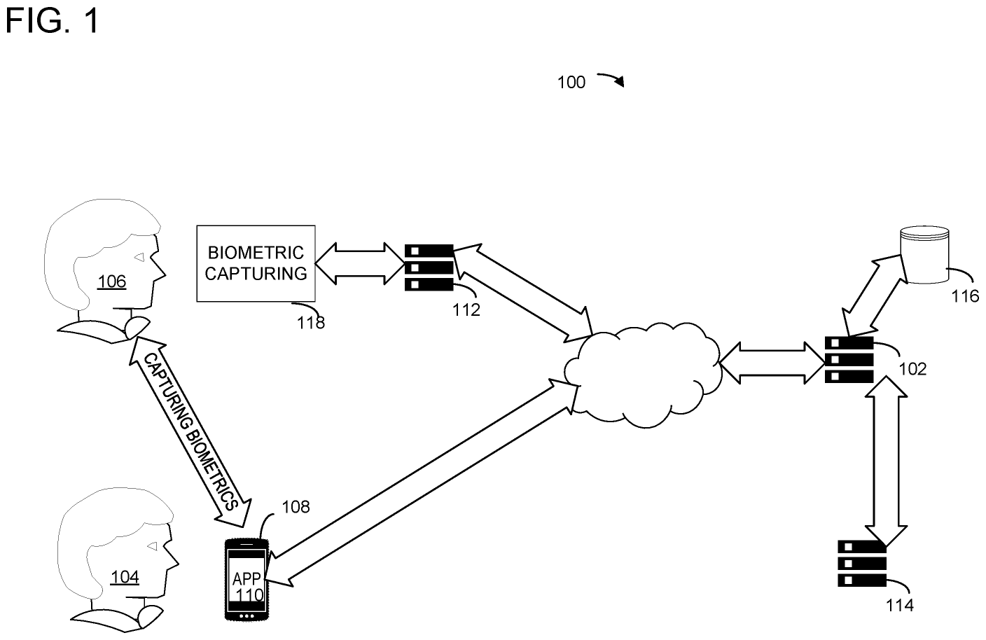

Referring to FIG. 1, a diagram illustrates a system 100 for enabling a transaction based on biometric parameters according to one embodiment. For example, the system 100 includes a payment processing network server 102 that may handle instructions from a consumer 104 (which may be a sender and may be used interchangeably as an example and not a limitation) regarding enabling a transaction based on biometric parameters of a recipient 106. As above example illustrated, the consumer 104 may be a sender who wishes to send funds to the recipient 106 for various reasons. In the example provided, the recipient 106 may be a panhandler or someone to whom the sender 104 wishes to provide assistance monetarily. In such a situation, it is the premise that the sender 104 lacks any personal or contact information of the recipient 106. The recipient 106 is a stranger to the sender 104.

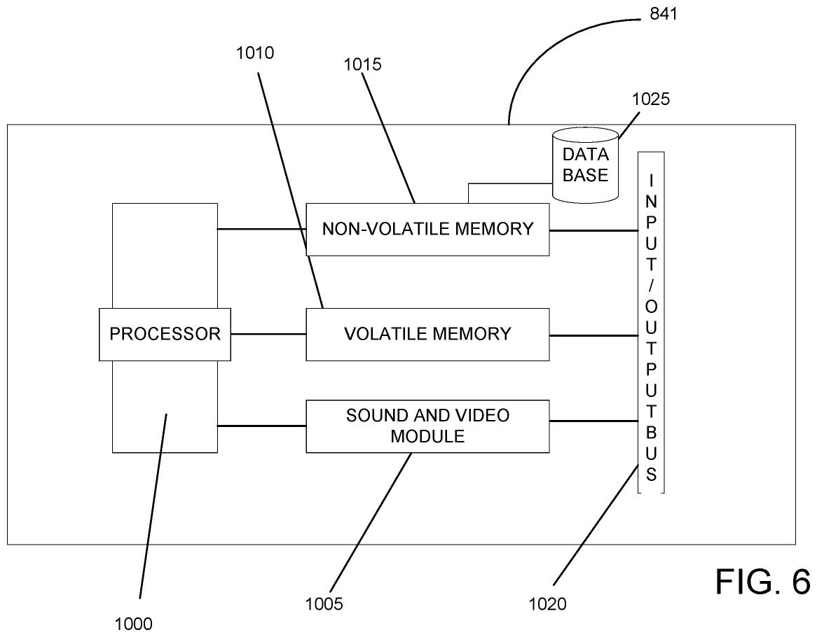

In another embodiment, the payment processing network server 102 may be multiple server computers scattered in various geographic locations around the world. The payment processing network server 102 may be linked by computer networks to individual computers and other collaborating computers in various institutions, such as shops, bank institutions, merchants, online store merchants, mobile wallets, front end servers serving clients, etc. Moreover, the payment processing network server 102 may include proprietary and/or standardized protocols, application programming interfaces (APIs), and other systems in place to handle transactions around the world. In one example, the transactions include credit card transactions, debit card transactions, etc., that are in compliance or adhere to the protocols and/or APIs of the payment processing network specification. In another embodiment, the payment processing network server 102 may include a computing device as depicted and described in FIG. 6.

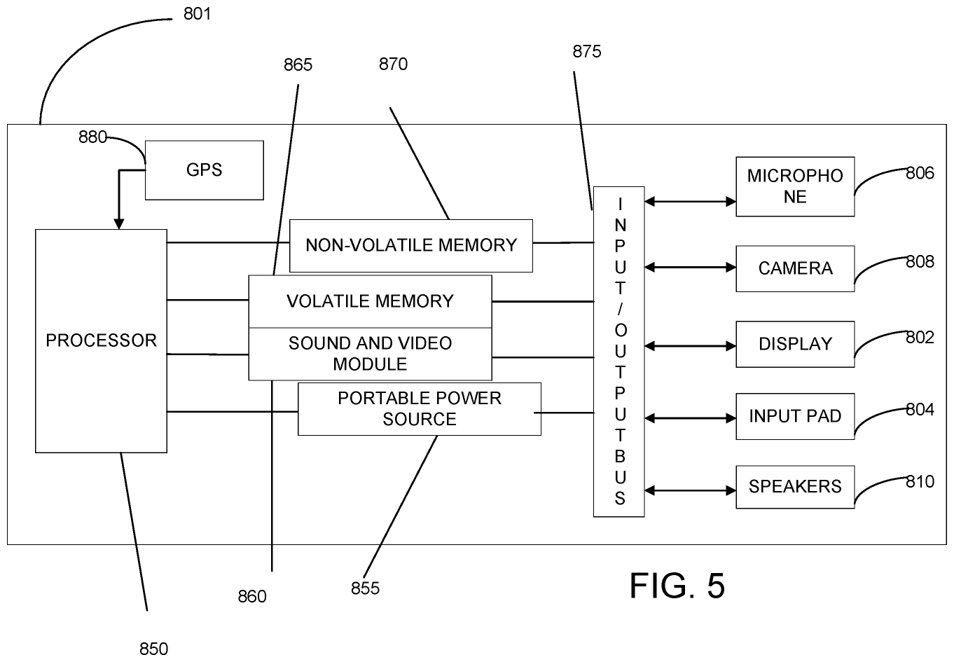

Still referring to FIG. 1, the sender 104 may possess a mobile device 108, which may be a similar device to a portable computing device as described and illustrated in FIG. 5. For example, the mobile device 108 may include a processor that is configured to execute computer-executable instructions stored in a memory of the mobile device 108. The computer-executable instructions may be organized or packaged in a form of an app or an application 110 executed by the processor. The app 110 may, after being executed, provide user interfaces on a display of the mobile device or via a microphone and a speaker to interact with the sender 104 to uses functions of the app 110.

In one embodiment, the app 110 may be a digital wallet app that is capable of interfacing a user account of the sender 104 and a financial institution that issues the account. For example, the sender 104 may include a credit card issued by a bank. Upon associating credentials of that credit card's online account via the app 110, the sender 104 may use the app 110 to access the user account to conduct business, such as using the credit card to send funds to another individual, such as the recipient 106, or a business entity, such as a merchant. In the example of the merchant, the merchant typically includes other devices, such as specific point-of-sale (POS) device, or identifying information with the payment processing network server 102 such that the sender 104 may engage to send funds to the merchant.

However, when it comes to individuals, in order for the sender 104 to send funds to another individual, unless the sender 104 knows the identity or some type of identifying information of the individual, current systems fail to provide a mechanism to sends funds. Moreover, assuming the sender 104 has knowledge of the identity or identifying information, if the individual does not have an account associated with some kind of institution, then the individual is unable to retrieve or obtain the funds sent from the sender 104.

Aspects of the invention attempt to provide a technical solution to this challenge. In one embodiment, the sender 104 uses the mobile device 108, via a camera and software associated therewith, to capture a photograph or an image of the recipient 106. For example, after the sender 104 receives permissions from the recipient 106, the sender 104 may use the camera associated with the mobile device 108 to take a facial image of the recipient 106. In one embodiment, the image needs not to be images that include specific facial features required by government agencies, such as the photograph/image needs to be in a white background, needs to include top of the ears, needs to be without glasses, etc.

In one embodiment, if the photograph or image is captured with high resolution, the photograph or image may include additional biometric detail, such as eye color, tattoos on parts of the body, etc.

In another embodiment, the image or photograph of the recipient 106 captured by the mobile device 108 may include objects that assist in identifying the recipient 106. For example, the background of the recipient 106 may be used to identify a proximity of the recipient 106 where the sender 104 engages the recipient 106. The recipient 106 may be disabled such that he or she may carry a card or sign that shows his name in alphabets or other languages.

In another embodiment, other biometrics may be collected. For example, instead of the image, the capturing of the recipient 106 may include a video having motion pictures and sound. For example, the video may include the recipient 106 announcing his or her name and that he or she gives permission for the video to be captured for the purpose of receiving funds from the sender 104.

In other words, the sender 104 may capture one or more pieces of biometric parameters of the recipient 106 via the mobile device 108, which may include a camera, a microphone, a speaker, or other peripheral devices or sensors that assist in collecting the biometric parameters from the recipient 106.

Again, it is understood that at the time of capturing the image or photograph of the recipient 106, the sender 104 is unaware of a user account of the recipient 106 or whether the recipient 106 has such an account. The sender 104 merely has the captured data via the mobile device 108.

Once collected, the sender 104 may store the captured data with the app 110 or the mobile device 108. As the sender 104 may wish to send funds to the recipient 106, the sender 104 may associate the captured data with the app 110 so that the sender 104 may associate with the amount of the funds and a sourcing account for the funds. For example, the sender 104 may wish to use a debit card or a credit card for sending the funds (e.g., $5.00). As such, the app 110 may collect the captured data along with the account information.

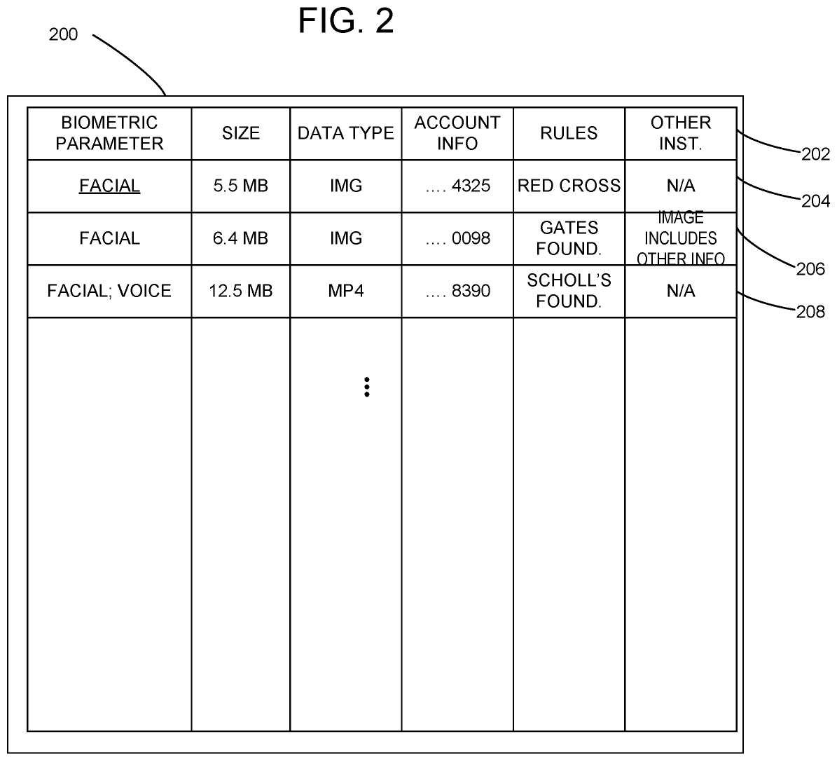

Referring now to FIG. 2, a diagram illustrating a data structure for storing the captured data at a database 116 associated with the payment processing network server 102. For example, once the app 110 has access to the captured data and the instructions from the sender 104 to send funds from a particular account to the recipient, the app 110 triggers a call to the payment processing network server 102. For example, the app 110 and the payment processing network server 102 may have an established protocol or API for transmitting the data packet to the payment processing network server 102. The payment processing network server 102 may then store the information in the data structure 200 shown in FIG. 2. For example, a heading 202 may identify the columns, such as:

Biometric parameter; size; data type; account information; rules; and other instructions.

In one embodiment, a row 204 may include the following information:

“Facial,” “5.5 MB;” and “IMG” identify the kind of biometric parameter (“facial”) and the size and format of the data (“5.5 MB” and “IMG” (short for image)). The data in the row 204 further includes information such as the source account (“. . . 4325” (using only the last four digits to protect privacy of the sender 104)) number. In another embodiment, the row 204 also includes “Red Cross” under the Rules column. In this example, the app 110, as part of the funding process, may present a graphical user interface (GUI) to enable the sender 104 to set rules in the event that the recipient 106 fails to establish an account to receive the funds. For example, the sender 104 may inform the recipient 106 that the recipient 106 may need to register or sign-up at a participating institution 112 using the same biometric parameter (e.g., photograph or image of the recipient's face). If the recipient 106 fails to register after a period, the funds may go to a charity of choice determined by the sender 104.

As such, the row 204 in FIG. 2 illustrates that the sender 104 has determined the unclaimed funds by the recipient 106 may be directed to the Red Cross. In one example, the period may be predetermined by the payment processing network server 102.

The row 204 may further include data for the column “other instructions.” For example, the row 204 may indicate that there are no other instructions from the sender 104. In another example, in row 206, the sender 104 may indicate that the biometric parameter (e.g., the image) may include additional information. In a further embodiment, the “Facial” biometric parameter in the row 204 is underlined, which may indicate that the particular parameter may be linked to the original source file that was sent from the sender 104 via the app 110. For example, such link may be http link point to a source location that may be accessible via the internet.

As a further embodiment, a row 208 may illustrate that the biometric parameter may include a “Facial,” as well as “Sound.”

It is also understood that other information may be stored by the payment processing network server 102, such as the name of the sender 104, or other identifying information of the sender 104. In yet another embodiment, the payment processing network server 102 may store a time stamp when the captured data and the instructions from the sender 104 was received at the payment processing network server 102.

Referring back to FIG. 1, the payment processing network server 102 may receive the captured data from the sender's mobile device 108. In one embodiment, the payment processing network server 102 may use facial recognition software to read the biometric parameter data received from the mobile device 108 to identify features associated with the recipient 106. In one example, the payment processing network 102 may store the identified data linked by the rows in FIG. 2, such as the underline link discussed above. In another embodiment, the location and the received biometric data may be encrypted to ensure that the data and the location are secured.

In another embodiment, depending on the data type of the biometric parameter, the payment processing network 102 may run other software to identify the biometric parameters. For example, the payment processing network server 102 may use a combination of facial recognition and voice recording software to capture the voice and facial features of the recipient 106. In another embodiment, the payment processing network server 102 may use other software to capture the background images, views, noises, sounds, etc., to identify a location or a proximity of locations of the recipient 106. This measure may be used to prevent fraud. For example, suppose the background of the image of the recipient 106 includes a location identifier (e.g., Chicago Union Station) and the image was sent to the payment processing network server 102 on Monday at 5:00 pm central time. If the recipient 106 appeared to try to register an account at a participating institution 116 in Houston, Tex. by 5:50 pm, given the amount of distance between Chicago, Ill. and Houston, Tex., the payment processing network server 102 may flag this registration as fraudulent or may be questionable.

Once saved, the payment processing network server 102 may store the data for a predetermined period of time. In one example, the time may be two-weeks or however long permitted by privacy regulations or laws permit. In another example, the length of time may be customized by the sender 104.

Once the biometric parameters have been identified and save, in one embodiment, the payment processing network server 102 may perform a search to determine whether the recipient 106 has registered an account with the payment processing network server 102. If a match is found, the payment processing network server 102 may forward the instructions from the sender 104 to an issuing institution 114 regarding transferring funds from the sender's sourcing account to the recipient's account.

If no match is found, the payment processing network server 102 stores the captured data until either the recipient 106 establishes or registers an account or the expiration of time. In one aspect, upon expiration of time, the payment processing network server 102 may redirect the funds to the charity of choice—according to the instructions of the sender 104. In such an example, the payment processing network server 102 may identify the bank institution that may receive such donations from anyone so that the funds from the sender 104 may be transferred from the issuing institution 114.

After the biometric data is captured and before the expiration of time to transfer, the recipient 106 may wish to register with the participating institution 112 to receive the funds. For example, the participating institution 112 may be a gas station, a grocery store, a supermarket, a bank institution, a credit union, a hospital, or other institutions where the recipient 106 might visit. The participating institution 112 may include a kiosk or a terminal that includes a biometric capturing device 118, such as a camera, a microphone, etc. The biometric capturing device 118 may also include a display or monitor for displaying the captured biometric and other input/output peripheral devices so that the recipient 106 may interact with the biometric capturing device 118. In another embodiment, the biometric capturing device 118 may be a computing device housed in the kiosk or the terminal of the participating institution 112.

The recipient 106 may initiate the process of registering with the participating institution 112 by permitting the biometric capturing device 118 to gather biometric parameters of the recipient 106. Similar to the capturing process via the mobile device 108 above, the biometric capturing device 118 may collect images, sounds, or videos of the recipient 106. In one embodiment, the biometric capturing device 118 may include a scanner for scanning fingerprints, or the like. Once the biometric parameters have been captured, the participating institution 112 may transmit the captured data to the payment processing network server 102 for matching. The payment processing network server 102, in one embodiment, first may process the biometric parameters by running biometric recognition (e.g., facial recognition software, noise cancellation software, audio enhancing software, etc.) to identify the biometric parameters.

In one embodiment, once the biometric parameters are identified, the payment processing network server 102 may compare the identified biometric parameters with existing biometric parameters collected from the sender 104 and stored in the database 116.

Once a match is found, the payment processing network server 102 may send a confirmation to the biometric capturing device 118 of the participating institution 112 to invite the recipient 106 to establish an account. In one embodiment, the recipient 106 may decide to use the same captured biometric parameter as the sole identity information for the recipient 106 to establish the account. In one embodiment, the account to be established may be an ad-hoc account, such as a pre-paid card or a gift card account hosted by the payment processing network server 102 so that, unlike a tradition checking account, a savings account, a debit card account, no additional information is needed from the recipient 106 or additional background checks.

In another embodiment, the recipient 106 may volunteer to provide additional information as part of the account establishment process. For example, the recipient 106 might volunteer his name as part of the account creation process.

Once the account has established with the payment processing network server 102, the payment processing network server 102 may perform a search to identify whether there is a match from previously saved biometric parameters that match with that of the recipient 106.

In one embodiment, the match may not be a one to one matching, meaning that multiple senders wish to transfer funds to one recipient 106. As such, the payment processing network server 102 may sum up all the funds from all accounts before transferring the total to the account of the recipient 106.

In one embodiment, the kiosk of the participating institution 112 or the participating institution 112 may then issue a pre-paid card associated with an ad-hoc account to the recipient 106.

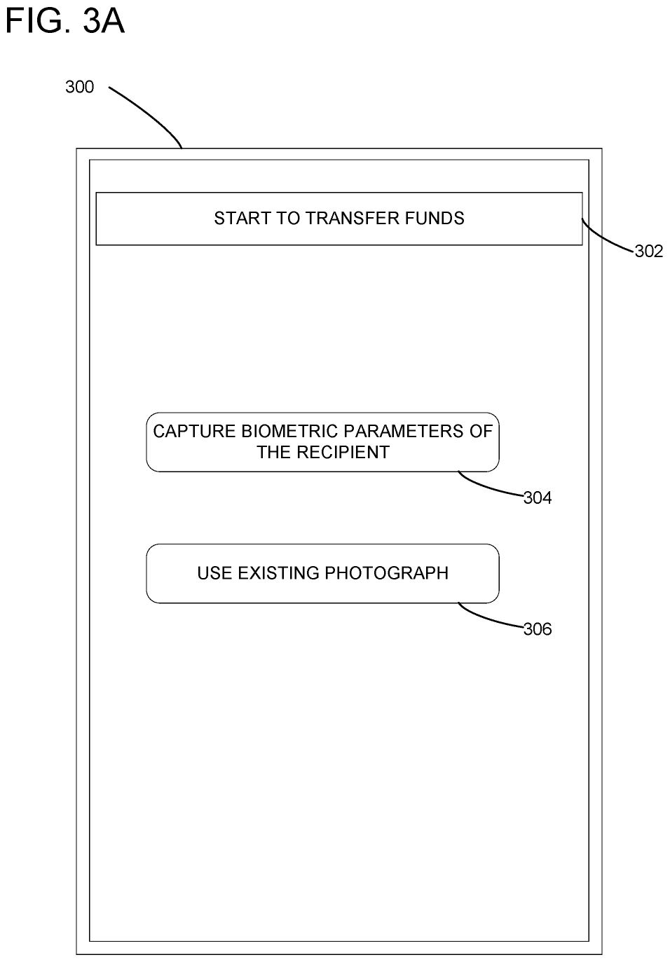

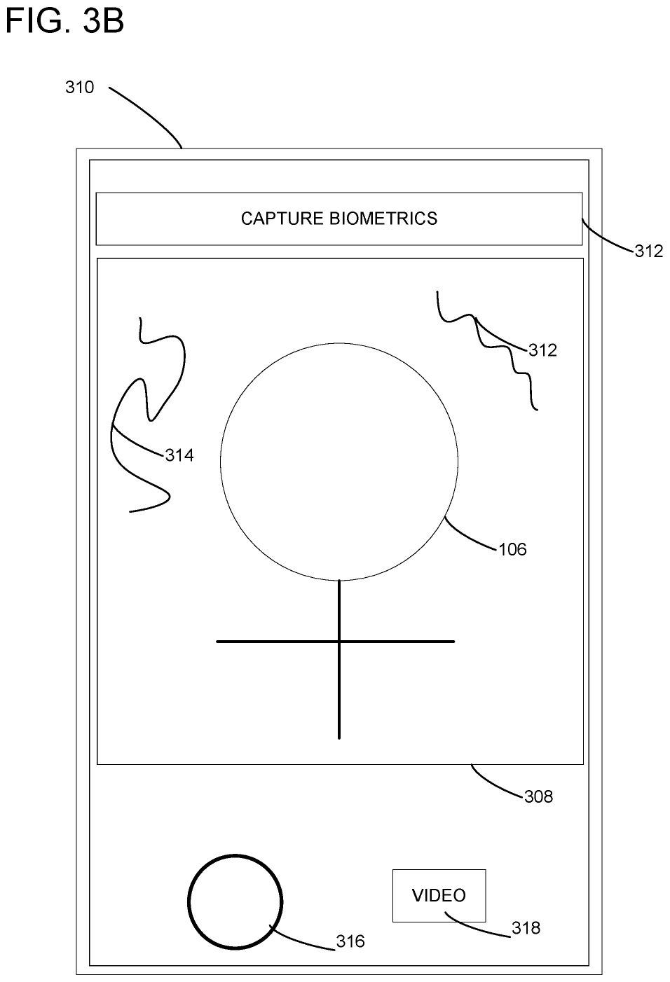

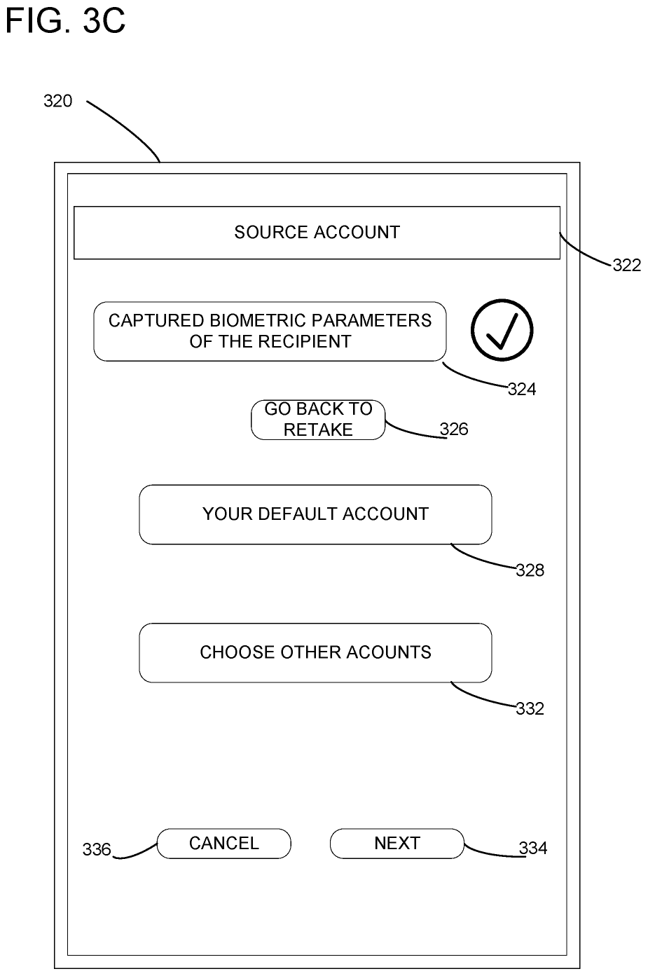

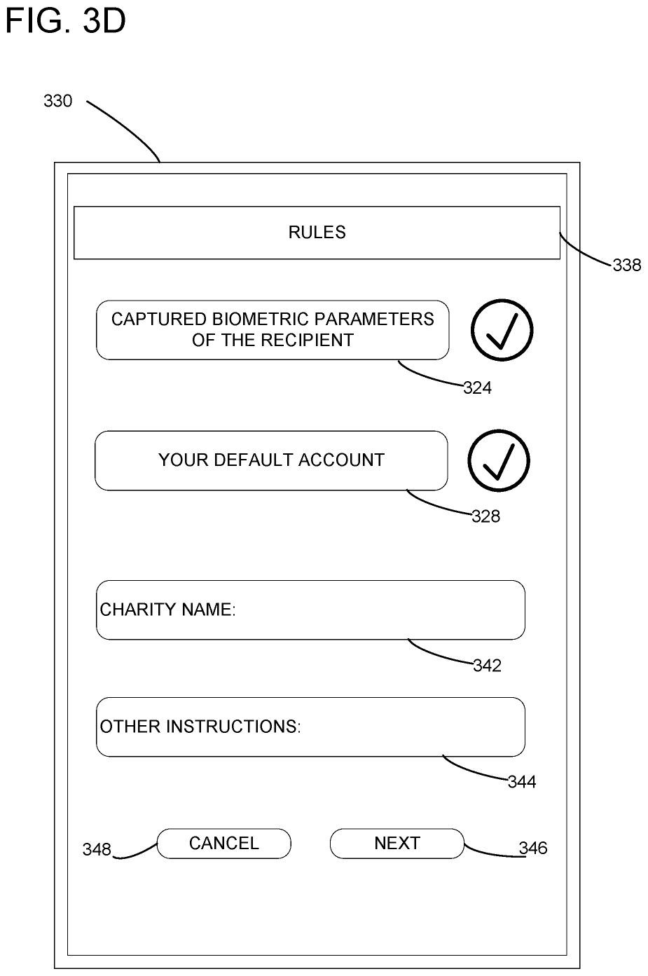

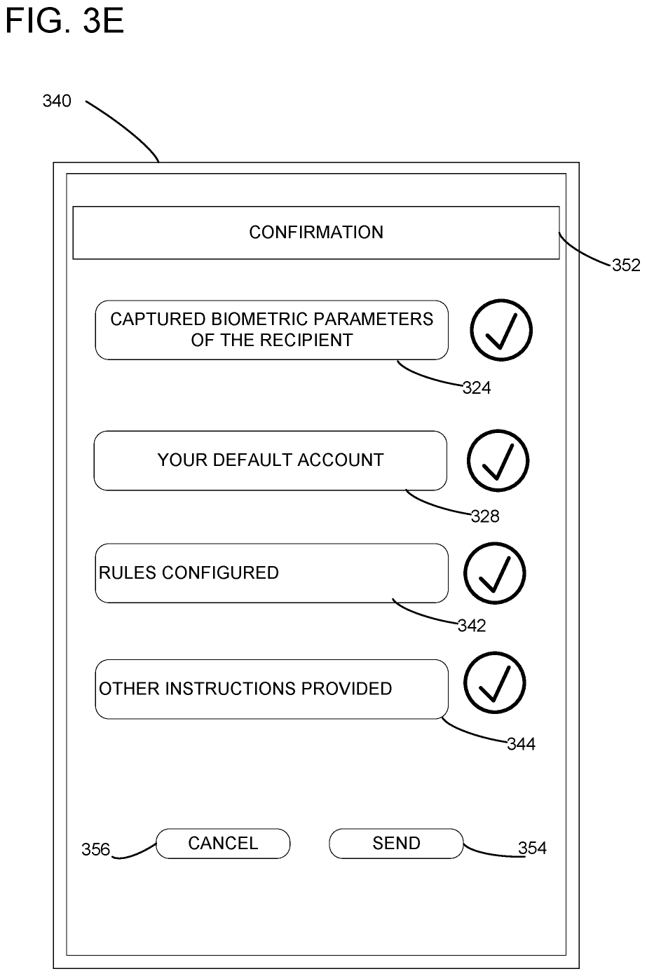

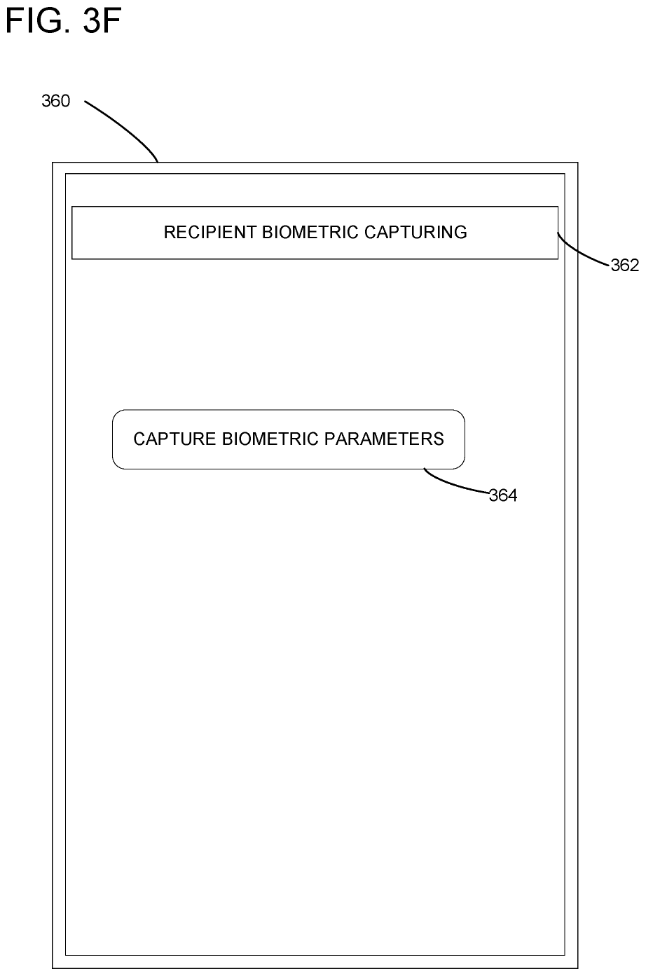

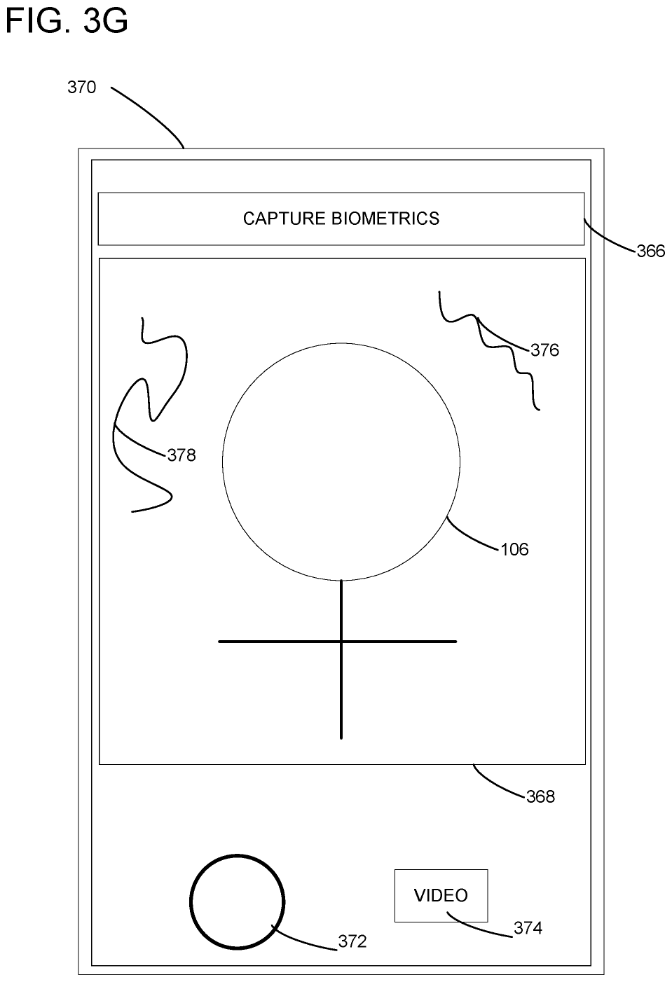

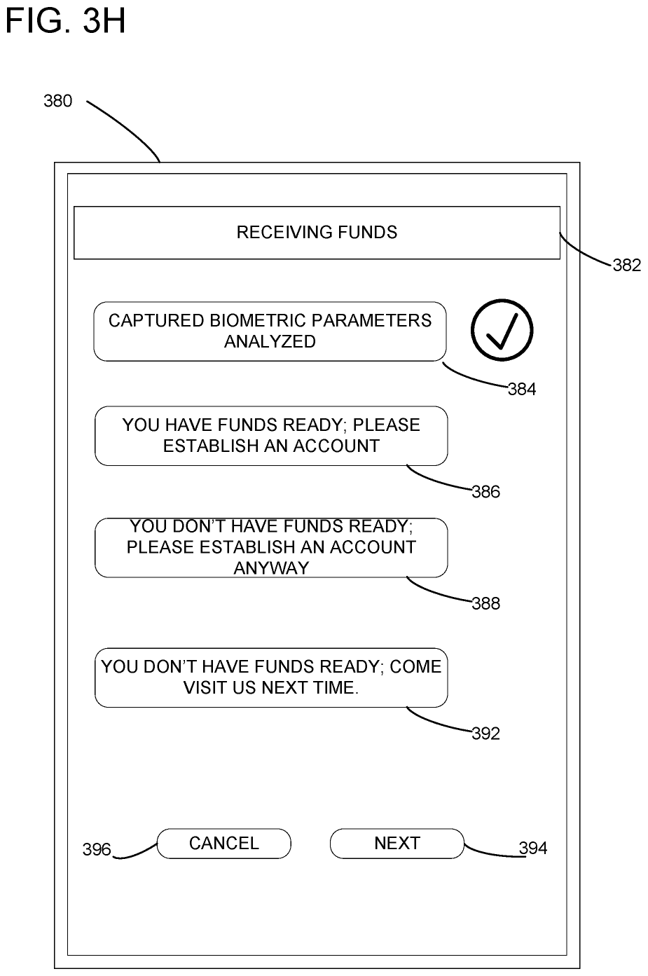

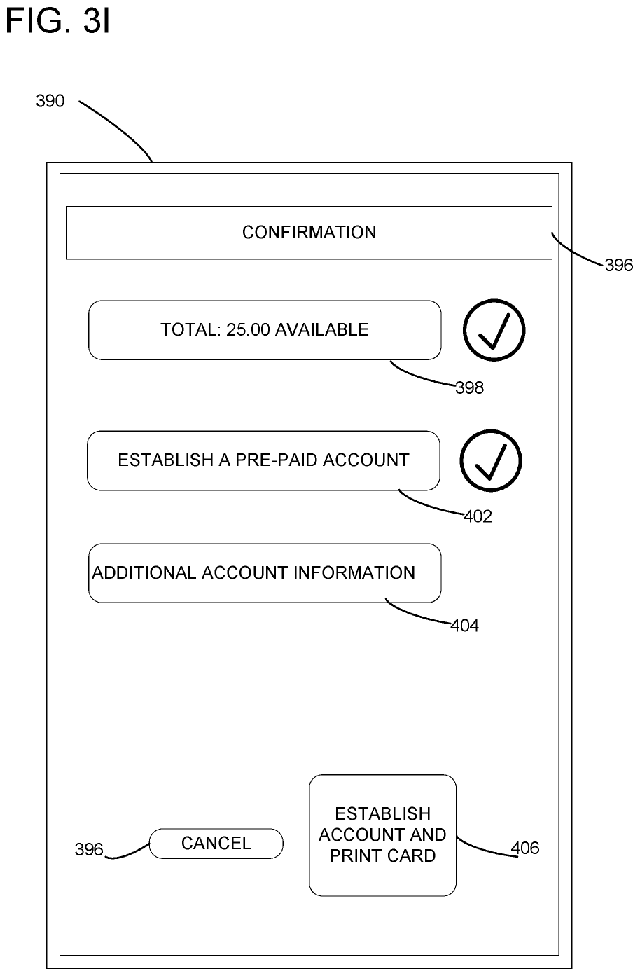

Referring now to FIG. 3A, a screenshot illustrating one embodiment for the sender 102 to transfer funds to the recipient 106. For example, the screenshot 300 may be a GUI designed to initiate the process. For example, the screenshot 300 may be presented on a mobile device, such as the mobile device 108. In another embodiment, the screenshot 300 may be presented as an initial GUI for the app 110. The screenshot 300 may include a first header 302 providing a header. The screenshot 300 may further provide a button 304 for enabling the sender 104 to capture biometric parameters of the recipient or a button 306 to use any existing photograph of the recipient that was taken previously.

Referring to FIG. 3B, the screenshot 310 may provide a different message in a header 312, and the message now displays “CAPTURE BIOMETRICS.” The screenshot 310 may be displayed after the sender 104 selects the button 304. In response, a frame 308 may be displayed so that the sender 104 may focus the camera lens of the mobile device 108 on the recipient 106 so that biometric parameters may be captured. In another embodiment, background objects 312 and 314 may also be captured. Once, the recipient 106 is in focus, the sender 104 may select button 316 to capture or save the biometric parameter (e.g., image/photograph) of the recipient 106. In another embodiment, the sender 104 may also capture a video of the recipient 106 via a video button 318.

Referring now to FIG. 3C, another screenshot 320 illustrates GUI after the biometric parameters have been captured. In one embodiment, a heading 322 may clearly identify the stage the sender 104 is in the process. In another embodiment, the screenshot 320 may include a link 324 to the captured biometric parameters of the recipient and the sender 104 may be given another opportunity to retake the biometric parameters if the sender 104 wishes to by selecting a button 326 “GO BACK TO RETAKE.”

In another embodiment, since the screenshot 320 is about the transfer, the sender 104 my select whether to choose a button 328 for selecting his or her default source account or a button 332 to choose other accounts in the sender's profile. For instance, the app 110 may be a digital wallet app and the sender 104 may have multiple accounts associated therewith. As such, by selecting the button 332, the sender 104 may choose other accounts to be the fund source. If the sender 104 selects the button 332, the sender 104 is taken to another screenshot to select the accounts and will be return to a similar screenshot as the 320. Once the fund source account is selected, the sender 104 may select a NEXT button 334 or a CANCEL button 336 to return to the previous screenshot 310.

Referring now to FIG. 3D, another screenshot 330 where the sender 104 may configure rules in the event that the recipient 106 fails to establish an account to receive the funds. For example, the sender 104 may enter a name of the charity in a field 342. In another embodiment, the sender 104 may further enter other instructions in a field 344. For example, the other instructions may include: “NAME OF RECIPIENT” in the picture; “VIDEO PROVIDED,” or other instructions that the sender 104 may wish to provide to the payment processing network server 102. Once the rules are configured, the sender 104 may select a NEXT button 346 or a CANCEL button 348 to return to the previous screenshot 320.

Referring now to FIG. 3E, a final confirmation screenshot 340 that the sender 104 may see before selecting a SEND button 354 to transfer funds to the recipient 106. Of course, if the sender 104 wishes to change its mind about any of the previous screenshots, he or she may select CANCEL button 356 to return to the previous screenshots to abort the process.

In another embodiment, a checkmark may be displayed next to a step after its completion to indicate to the sender 104 that the step or information has been completed.

Upon selecting the SEND button, the biometric parameter data of the recipient 106, and account information along with any rules and/or additional instructions that the sender 104 may wish to provide are sent to the payment processing network server 102 for further analysis and storage, as discussed above.

Referring to FIG. 3F, a screenshot 360 for the participating institution 112 to provide to the recipient 106 at a kiosk or a terminal for the recipient 106 to register and verify. For example, the recipient 106 may first select a button “CAPTURE BIOMETRIC PARAMETERS” 364 to begin the process.

Referring to FIG. 3G, a screenshot 370 enables the recipient to capture the biometric parameters, such as a photograph of the recipient or a video of the recipient. The recipient may place himself or herself with a frame 368, which may also capture background objects 376 and 378. Once ready, the recipient 106 may either capture the photograph by selecting a button 372 or a video by selecting a video button 374.

At FIG. 3H, a header bar 382 may display the status of “RECEIVING FUNDS” to the recipient. Another GUI display element 384 may indicate to the recipient 106 that the captured biometric parameters have been analyzed. In one embodiment, the recipient 106 may see a GUI 386 indicating that there are funds ready for him or her and that the recipient 106 may proceed to establish an account. Alternative, a GUI 388 may indicate to the recipient 106 that there are no funds waiting for the recipient and that the recipient 106 may establish an account now. In yet another embodiment, a GUI element 392 may indicate to the recipient 106 that there are no funds available and that he or she may return next time.

If the recipient 106 selects the GUI element 386 or 388, the recipient 106 may select NEXT 394 to continue to establish an account. Otherwise, the recipient 106 may select CANCEL 396 to abort or the GUI element 392 to abort.

Referring now to FIG. 3I, a screenshot 390 may identify a CONFIRMATION header 396 to the recipient 106. The screenshot 390 further illustrates a GUI element 398 indicating a total amount of funds are available to the recipient 106. The recipient 106 may further select a GUI element 402 to establish an account. In one example and as discussed above, the recipient 106 may establish an ad-hoc (such as a pre-paid) account with the payment processing network server 102 without any additional identifying information other than what has already been collected from the recipient 106. Once the recipient 106 selects the GUI element 402, the recipient 106 may volunteer additional information by entering that in a GUI element 404. Once the recipient 106 is ready, he or she may select a button 406 to establish the account and have the kiosk or the participating institution 112 to print the pre-paid card with the funds included therein. Otherwise, the recipient 106 may select CANCEL button 356 to cancel the process.

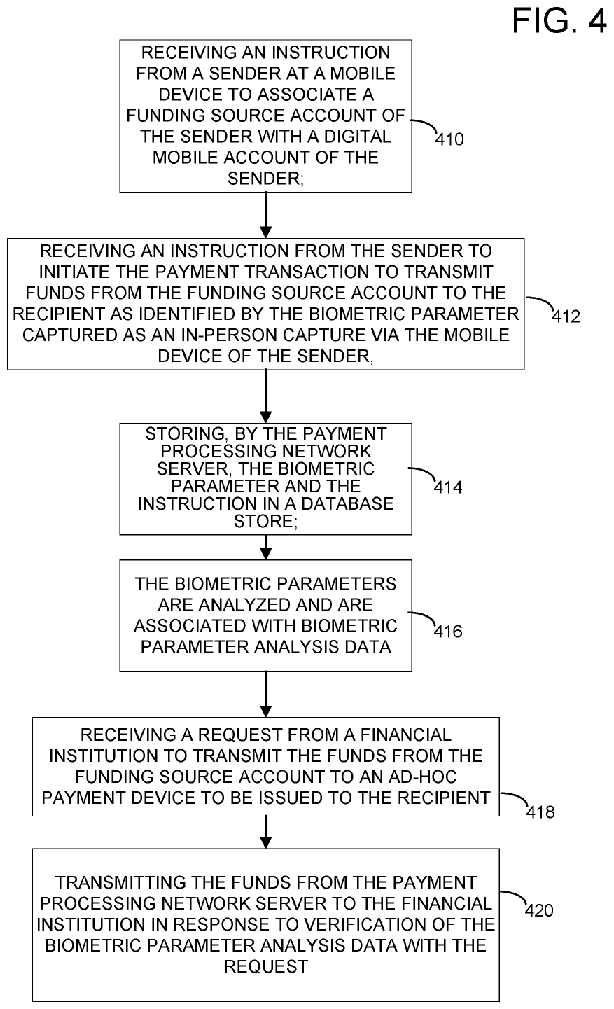

Referring now to FIG. 4, a flow chart illustrates a computer-implemented method for enabling fund transfers based on biometric parameters. In one embodiment, at 410, a payment processing network server receives an instruction from the sender at a mobile device to associate a funding source account of the sender with a digital mobile account of the sender. In one embodiment, the digital mobile account includes a digital wallet account accessible by the user on the mobile device via an app, such as the app 110. At 412, the payment processing network server 102 may an instruction from the sender to initiate the payment transaction to transmit funds from the funding source account to the recipient as identified by the biometric parameter captured as an in-person capture via the mobile device of the sender. In one embodiment, the sender 104 is unaware of the destination account information of the recipient 106 and that the sender 104 does not have any advance information of the recipient 106 other than the biometric parameters that are captured in the in-person capture.

At 414, the biometric parameters are stored, and at 416, the biometric parameters are analyzed and are associated with biometric parameter analysis data. At 418, the payment processing network server receives a request from a financial institution to transmit the funds from the funding source account to an ad-hoc payment device to be issued to the recipient, wherein the financial institution lacks an affiliated account with the recipient. At 420, the payment processing network server transmits or transfers the funds from the payment processing network server to the financial institution in response to verification of the biometric parameter analysis data with the request.

In yet another embodiment, aspects of the invention may enable the sender 104 to take a picture of a façade or a sign of institution so that the payment processing network server 102 may use image processing or optical character recognition (OCR) software to identify the identity of the institution. Once identified, instead of having the sender 104 searching for the proper/correct banking institutions to receive donations from the sender 104, the payment processing network server 102 may automatically search for the account information or the like before facilitate the sender 104 to transfer funds to the institution.

FIG. 5 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc. FIG. 5 may be a simplified illustration of the physical elements that make up a portable computing device 801 and FIG. 6 may be a simplified illustration of the physical elements that make up a server type computing device 841.

FIG. 5 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 6. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments will become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods described herein may be configured for improving transaction initiation solely based on biometric parameters of an individual and when the individual does not yet have an account to receive funds from a sender. Further advantages and modifications of the above described system and method will readily occur to those skilled in the art.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computer-implemented method for initiating a payment transaction from a sender to a recipient, wherein the recipient lacks a destination account with a financial institution, the computer-implemented method comprising:
receiving an instruction from the sender at a mobile device to associate with a funding source account of the sender;
receiving a biometric parameter of the recipient captured by the mobile device as an in-person capture;
storing at least a portion of the biometric parameter on the mobile device;
receiving an instruction from the sender to initiate the payment transaction to transmit funds from the funding source account to the recipient as identified by the biometric parameter; and
transmitting the biometric parameter and the user instruction to a payment server to complete the payment transaction.

2. The computer-implemented method of claim 1, wherein the funding source account of the sender comprises a credit card account.

3. The computer-implemented method of claim 1, wherein the biometric parameter comprises a frontal facial image of the recipient captured by a camera of the mobile device.

4. The computer-implemented method of claim 3, wherein the frontal facial image comprises a two-dimensional frontal facial image of the recipient.

5. The computer-implemented method of claim 1, wherein the biometric parameter comprises at least one of the following: sound data, image data, fingerprint data, and a combination of sound, image, and fingerprint data.

6. A computer-implemented method for initiating a payment transaction from a sender to a recipient using a biometric parameter of the recipient as the sole identifier comprising:
receiving, at a payment processing network server, an instruction from the sender at a mobile device to associate a funding source account of the sender with a digital mobile account of the sender;
receiving an instruction from the sender to initiate the payment transaction to transmit funds from the funding source account to the recipient as identified by the biometric parameter captured as an in-person capture via the mobile device of the sender;
storing, by the payment processing network server, the biometric parameter and the instruction in a database store;
associating biometric parameter analysis data with the stored biometric parameter in the database store;
receiving, by the payment processing network server, a request from a financial institution to transmit the funds from the funding source account to an ad-hoc payment device to be issued to the recipient, wherein the financial institution lacks an affiliated account with the recipient; and
transmitting the funds from the payment processing network server to the financial institution in response to verification of the biometric parameter analysis data with the request.

7. The computer-implemented method of claim 6, wherein the biometric parameter comprises facial recognition image data of the recipient taken by a camera associated with the financial institution.

8. The computer-implemented method of claim 7, wherein the facial recognition image data comprises frontal facial image data of the recipient.

9. The computer-implemented method of claim 6, wherein the ad-hoc payment device comprises a gift card issued by the financial institution.

10. The computer-implemented method of claim 6, wherein the funding source account of the sender comprises a credit card account.

11. The computer-implemented method of claim 6, wherein the biometric parameter of the recipient comprises at least one of the following: sound data, image data, fingerprint data, and a combination of sound, image, and fingerprint data.

12. The computer-implemented method of claim 8, wherein the frontal facial image comprises a two-dimensional frontal facial image of the recipient.

13. A system for initiating a payment transaction from a sender to a recipient using a biometric parameter of the recipient as the sole identifier comprising:
a payment processing network server comprising a processor configured to execute computer-executable instructions stored in a memory, wherein the processor is configured to execute the computer-executable instructions for:
receiving, at a payment processing network server, an instruction from the sender at a mobile device to associate a funding source account of the sender with a digital mobile account of the sender, the mobile device being communicative to the payment processing network server via a computer network communication;
receiving an instruction from the sender to initiate the payment transaction to transmit funds from the funding source account to the recipient as identified by the biometric parameter captured as an in-person capture via the mobile device of the sender;
storing, by the payment processing network server, the biometric parameter and the instruction in a database store;
associating biometric parameter analysis data with the stored biometric parameter in the database store;
receiving, by the payment processing network server, a request from a financial institution to transmit the funds from the funding source account to an ad-hoc payment device to be issued to the recipient, wherein the financial institution lacks an affiliated account with the recipient; and
transmitting the funds from the payment processing network server to the financial institution in response to verification of the biometric parameter analysis data with the request.

14. The system of claim 13, wherein the biometric parameter comprises facial recognition image data of the recipient taken by a camera associated with the financial institution.

15. The system of claim 14, wherein the facial recognition image data comprises frontal facial image data of the recipient.

16. The system of claim 13, wherein the ad-hoc payment device comprises a gift card issued by the financial institution.

17. The system of claim 13, wherein the funding source account of the sender comprises a credit card account.

18. The system of claim 13, wherein the biometric parameter of the recipient comprises at least one of the following: sound data, image data, fingerprint data, and a combination of sound, image, and fingerprint data.

19. The system of claim 15, wherein the frontal facial image comprises a two-dimensional frontal facial image of the recipient.
